(19) United States
(12) Patent Application Publication
(10) Pub. No.: US 2019/0042995 A1
(43) Pub. Date: Feb. 7, 2019

(54) Automated Item Assortment System

(71) Applicant: Walmart Apollo, LLC, Bentonville, AR (US)

(72) Inventors: Behzad Nemati, Springdale, AR (US); Ehsan Nazarian, Rogers, AR (US)

(21) Appl. No.: 16/000,225

(22) Filed: Jun. 5, 2018

Related U.S. Application Data
(60) Provisional application No. 62/540,807, filed on Aug. 3, 2017.

(51) Int. Cl. G06Q 10/06; G06Q 10/04

(52) U.S. Cl. CPC G06Q 10/06315; G06Q 10/04

(57) ABSTRACT

An example system for solving a non-deterministic polynomial-time problem associated with item assortment selection from a plurality of items is described. The system includes databases configured to electronically store data corresponding to item categories and attributes of items. The system includes a computing system configured to receive a selection of an item category, determine items and attributes of the items associated with the selected item category, select a sample of the items, execute a first module to generate a first assortment from the sample of the items (the first module executing according to a non-polynomial processing time), and execute a second module to generate a second assortment from the sample of the items. The computing system validates the second assortment based on the first assortment and executes the second module to generalize the second assortment for the total number of items according to a polynomial processing time.

### CROSS-REFERENCE TO RELATED APPLICATIONS

This application claims the benefit of co-pending, commonly assigned U.S. Provisional Patent Application No. 62/540,807, which was filed on Aug. 3, 2017. The entire content of the foregoing provisional patent application is incorporated herein by reference.

### BACKGROUND

The process for determining an assortment of the selected items can have a computational complexity that results in large execution processing times that can increase exponentially as the number of items increases.

### SUMMARY

Exemplary embodiments of the present disclosure provide a system for solving a non-deterministic polynomial-time problem associated with automated item assortment selection from a plurality of items in an efficient manner. The system includes a computing system configured to select a sample of items from a selected category that is only a subset of a total number of items of the selected category. The computing system executes a first module to determine assortment of the sample of items according to a non-polynomial processing time, and further executes a second module on the sample of items according to a polynomial processing time. Based on a validation of the second module assortment relative to the first module assortment, the computing system generalizes assortment for the total number of items using the second module according to the polynomial processing time. Thus, rather than exponential growth in execution processing time for determining optimal assortment of the total number of items, the system generalizes the optimal assortment using the second module to provide a solution according to a polynomial processing time, resulting in an efficient use of computing resources to generate an assortment of items for a large number of shelves and items (and/or item categories).

In accordance with embodiments of the present disclosure, an exemplary system for solving a non-deterministic polynomial-time problem associated with automated item assortment selection from a plurality of items is provided. The system includes one or more databases configured to electronically store data corresponding to one or more item categories and one or more attributes of items associated with each of the one or more item categories. The system includes a computing system in communication with the one or more databases. The computing system can be configured to electronically receive, as input at a user interface, a selection of an item category from the one or more item categories. The computing system can be configured to electronically determine items and attributes of the items associated with the selected item category. The computing system can be configured to electronically select a sample of the items associated with the selected item category. The sample can include a subset of a total number of the items associated with the selected item category (e.g., approximately 1-3%, approximately 1-5%, approximately 1-10%, or the like).

The computing system can be configured to electronically execute a first module to generate a first assortment from the sample of the items based on the attributes of the items. The first module can execute according to a non-polynomial processing time, which increases exponentially as the number of items increases. The computing system can be configured to electronically execute a second module to generate a second assortment from the sample of the items based on the attributes of the items. The second module can execute according to a polynomial processing time, which increases according to a polynomial equation as the number of items increases. The computing system can be configured to electronically validate the second assortment based on the first assortment. In response to validating the second assortment of the sample of the items, the computing system can be configured to electronically execute the second module to generalize the second assortment for the total number of items associated with the selected item category based on the attributes of the total number of items. The second module can be executed to generalize the second assortment for the total number of items according to a polynomial processing time.

The one or more attributes of the items can include, e.g., an item name, item dimensions, item volume, item linear space, item price, item sales information, item profits, item demand, item historical data, item category, item uniqueness, competitor item similarity, competitor item sales, competitor item profits, combinations thereof, or the like. The one or more databases can be configured to electronically store data corresponding to one or more attributes of shelves in the one or more item categories. In some embodiments, the one or more attributes of the shelves can include at least one of a shelf location, a shelf category, shelf dimensions, combinations thereof, or the like.

The computing system can be configured to rank the items based on a profit-to-dimension ratio. The items with a high profit-to-dimension ratio can be ranked higher than items with a low profit-to-dimension ratio. The selected sample of the items can include a combination of items with a high-volume sales history, items with a mid-volume sales history, and items with a low-volume sales history, thereby representing items having a wide variety of sales histories. The selected sample of the items can therefore be representative of the total number of the items associated with the selected item category.

The first module can determine the first assortment of the sample of the items based on shelf dimensions of one or more shelves of the selected item category. The first assortment of the sample of the items can include a location of each item on a shelf, a number of each item on the shelf, and the number of facings for an item. In some embodiments, the computing system can be configured to receive as input at the user interface an assortment criteria for the selected item category in the form of an assortment level percentage.

In some embodiments, the assortment level percentage can be below 100%. The computing system can be configured to validate the second assortment of the sample of the items based on whether the second assortment meets or exceeds the assortment criteria. The computing system can be configured to output to the user interface a generalized assortment for the total number of items associated with the selected item category based on the generalization of the second assortment. In some embodiments, the first module can be a mixed integer model or algorithm. In some embodiments, the second module can be a meta-heuristic model or algorithm.

In accordance with embodiments of the present disclosure, an exemplary non-transitory computer-readable medium storing instructions for solving a non-deterministic polynomial-time problem associated with automated item assortment selection from a plurality of items is provided. The instructions can be executed by a processing device of a computing system. Execution of the instructions by the processing device causes the processing device to electronically store in one or more databases data corresponding to one or more item categories and one or more attributes of items associated with each of the one or more item categories. Execution of the instructions by the processing device causes the processing device to receive, as input at a user interface, a selection of an item category from the one or more item categories. Execution of the instructions by the processing device causes the processing device to determine items and attributes of the items associated with the selected item category.

Execution of the instructions by the processing device causes the processing device to select a sample of the items associated with the selected item category. The sample can include a subset of a total number of the items associated with the selected item category. Execution of the instructions by the processing device causes the processing device to execute a first module to generate a first assortment from the sample of the items based on the attributes of the items. The first module can execute according to a non-polynomial processing time. Execution of the instructions by the processing device causes the processing device to execute a second module to generate a second assortment from the sample of the items based on the attributes of the items.

Execution of the instructions by the processing device causes the processing device to validate the second assortment based on the first assortment. In response to validating the second assortment of the sample of the items, execution of the instructions by the processing device causes the processing device to execute the second module to generalize the second assortment for the total number of items associated with the selected item category based on the attributes of the total number of items. The second module can be executed to generalize the second assortment for the total number of items according to a polynomial processing time. In some embodiments, execution of the instructions by the processing device can cause the processing device to rank the items based on a profit-to-dimension ratio. Execution of the instructions by the processing device causes the processing device to execute the first module to determine the first assortment of the sample of the items based on shelf dimensions of one or more shelves of the selected item category.

Execution of the instructions by the processing device causes the processing device to receive as input at the user interface an assortment criteria for the selected item department in the form of an assortment level percentage. Execution of the instructions by the processing device causes the processing device to validate the second assortment of the sample of the items based on whether the second assortment meets or exceeds the assortment criteria. Execution of the instructions by the processing device causes the processing device to output to the user interface a generalized assortment for the total number of items associated with the selected item category based on the generalization of the second assortment.

In accordance with embodiments of the present disclosure, an exemplary method of solving a non-deterministic polynomial-time problem associated with automated item assortment selection from a plurality of items is provided. The method includes electronically storing in one or more databases data corresponding to one or more item categories and one or more attributes of items associated with each of the one or more item categories. The method includes receiving, as input at a user interface, a selection of an item category from the one or more item categories. The method includes determining items and attributes of the items associated with the selected item category. The method includes selecting a sample of the items associated with the selected item category. The sample can include a subset of a total number of the items associated with the selected item category.

The method includes executing a first module to generate a first assortment from the sample of the items based on the attributes of the items. The first module can execute according to a non-polynomial processing time. The method includes executing a second module to generate a second assortment from the sample of the items based on the attributes of the items. The method includes validating the second assortment based on the first assortment. In response to validating the second assortment of the sample of the items, the method includes executing the second module to generalize the second assortment for the total number of items associated with the selected item category based on the attributes of the total number of items. The second module can be executed to generalize the second assortment for the total number of items according to a polynomial processing time.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the automated item assortment optimization system, reference is made to the accompanying figures, wherein:

FIG. 1 is a block diagram of an exemplary automated item assortment optimization system of the present disclosure;

FIG. 2 is a block diagram of an exemplary database of an automated item assortment optimization system of the present disclosure;

FIG. 3 is a block diagram of a computing device in accordance with exemplary embodiments of the present disclosure;

FIG. 4 is a block diagram of an exemplary distributed system environment in accordance with embodiments of the present disclosure; and

FIG. 5 is a flowchart illustrating a process implemented by an exemplary automated item assortment optimization system in accordance with embodiments of the present disclosure.

### DETAILED DESCRIPTION

Exemplary embodiments of the present disclosure provide a system for solving a non-deterministic polynomial-time problem associated with automated item assortment selection from a plurality of items in a computer resource efficient manner. In particular, the system initially relies on a combination of a non-polynomial execution/processing time model and a polynomial execution/processing time model during an assortment validation step for a sample of the selected items. After a validation criteria is met, the system generalizes the polynomial processing time model to optimize assortment of the total number of selected items, where the execution/processing time increases according to a polynomial equation as the number of selected items increases. The sample assortment therefore acts as a representative assortment, and the polynomial processing time model ensures an efficient (i.e., non-exponential) increase in execution/processing time for determining the optimal assortment of the items. The difference in execution/processing time between the non-polynomial and polynomial processing time models increases as the number of items increase such that the more items that are included in the computations the faster the polynomial processing time model is over the non-polynomial processing time model.

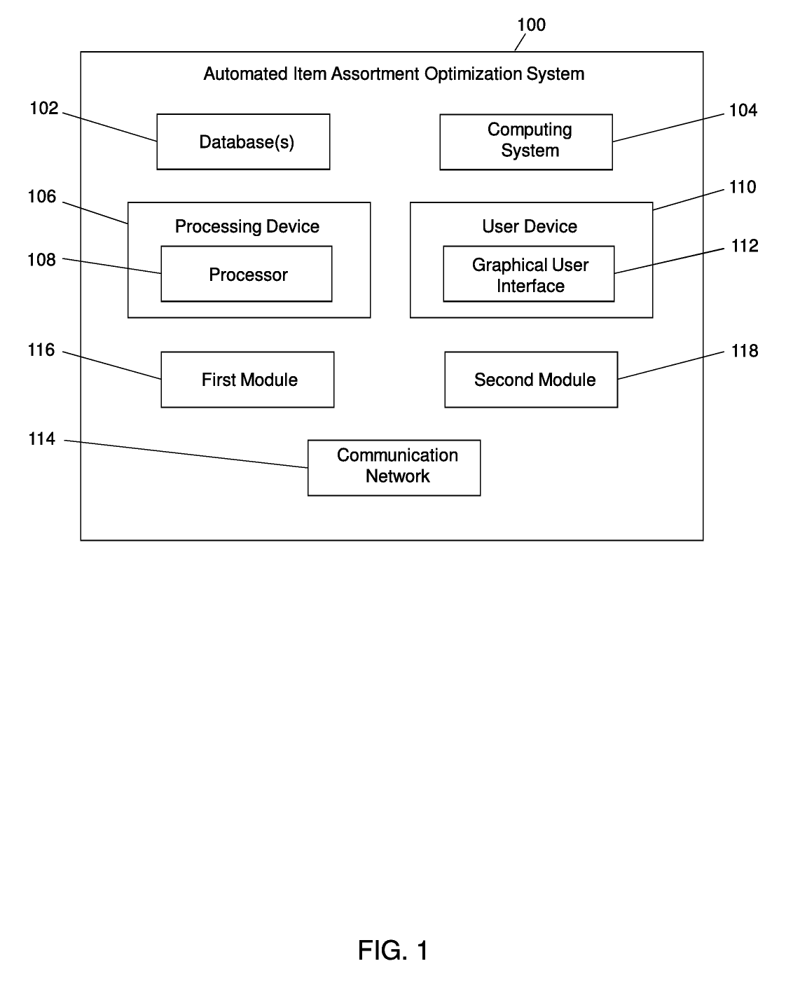

FIG. 1 is a block diagram of an exemplary automated item assortment optimization system 100 (hereinafter “system 100”) of the present disclosure. The system 100 includes one or more databases 102 configured to electronically receive and store data corresponding to item categories of a retail environment (e.g., sports, toys, electronics, housewares, clothing, canned goods, boxed goods, beverages, pharmacy, or the like). The databases 102 are also configured to electronically receive and store data corresponding to item attributes for each respective category (e.g., item name, item dimensions, item volume, item linear space, item price, item sales information, item profits, item demand, item historical data, item category, item uniqueness, competitor item similarity, competitor item sales, competitor item profits, combination thereof, or the like). The databases 102 are also configured to electronically receive and store data corresponding to shelf attributes for each of the categories (e.g., shelf location, shelf category, shelf dimensions, combinations thereof, or the like). Details of the databases 102 will be discussed below and with respect to FIG. 1.

The system 100 includes a computing system 104 in wired and/or wireless communication with the databases 102. The system 100 can include a processing device 106 including a processor 108. The system 100 includes a user interface 110 with a graphical user interface (GUI) 112 configured to receive, transmit and display data to a user. The system 100 can include a communication interface or network 114 configured to provide electronic communication and data transfer between components of the system 100.

The system 100 includes two modules 116, 118 that are executed by the computing system 104 (and/or the processing device 106) for generating an assortment of items for a selected category to determine and output an optimal assortment of the items at the GUI 112. The first module 116 can execute according to a non-polynomial execution/processing time. In some embodiments, the first module 116 can be a mixed integer module or algorithm. The second module 118 can execute according to a polynomial execution/processing time. In some embodiments, the second module 118 can be a meta-heuristic model or algorithm.

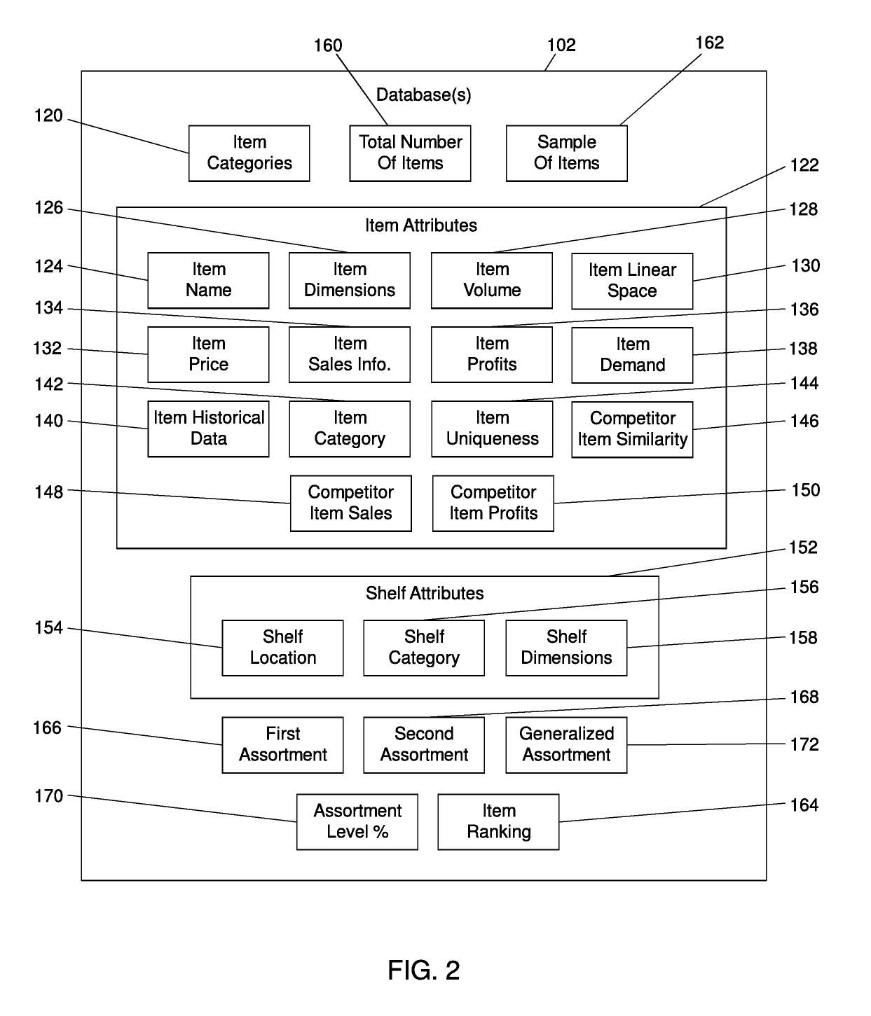

With reference to FIG. 2, a block diagram of an exemplary database 102 is shown. Although shown as electronically storing data in a single database 102, it should be understood that one or more databases 102 can be used to store data in a distributed manner. The database 102 electronically stores data corresponding to item categories 120 of a retail environment, including the items associated with each type of item category 120. For example, the database 102 can store a correlation between canned fruits, canned vegetables, and canned pasta sauce, and the item category 120 of canned goods. As a further example, the database 102 can store a correlation between boxes of pasta, cereal, and boxed cookies, and the item category 120 of boxed goods.

The database 102 electronically stores data corresponding to a variety of item characteristics or attributes 122 for each item located in the item categories 120. As an example, the item attributes 122 can include (but are not limited to) item names 124, item dimensions 126, item volume 128, item linear space 130, item price 132, item sales information 134, item profits 136, item demand 138, item historical data 140, item category 142, item uniqueness 144, competitor item similarity 146, competitor item sales 148, and competitor item profits 150. The item name 124 can include the brand name and/or generic item descriptor. The item dimensions 126 can include the height, width and length of the item. The item dimensions 126 can also include general characteristics of the item, such as the non-linear characteristics of an item (e.g., if the item is not in a box), the item shape, the item weight, or the like.

The item volume 128 can include the volume of the item as determined from the item dimensions 126. The item linear space 130 can include the dimensions of the part of the item that is required to face the user from the shelf (e.g., the amount of linear shelf space the item occupies when placed on the shelf for display). The item price 132 includes the current and any historical pricing of the item. The item sales information 134 includes the current and historical sales trends of the item, such as the number of items sold per hour, per day, per week, per month, per year, or the like, and the time in which the items were sold (e.g., fast selling or slow selling items). The item profits 136 includes the profits made by the retail environment from sales of the item over a particular time period. The item demand 138 includes information on the consumer demand of a particular item. The item historical data 140 includes data corresponding to the demand, availability, sales, pricing, or the like, of a particular item for a predetermined period of time. The item category 142 includes information on the particular item category 120 in which the item is generally displayed on the shelf.

The item uniqueness 144 includes characteristics of one item as compared to similar items that make the particular item unique. For example, if only one brand of pasta offers whole grain pasta while the remaining brands of pasta do not, this characteristic can be noted and stored in the item uniqueness 144. In general, when assorting items, including items having unique characteristics is desired to attract customers. In some embodiments, items having similar characteristics can be interchanged by the system 100 or by the user via the GUI 112 if a particular item is not available after an assortment has been generated. The competitor item similarity 146 includes a comparison between similar items (e.g., similar brands of pasta) and includes data corresponding to the similarities and differences between the items. In general, when assorting items, it is not desirable to include multiple competing items if such items have substantially similar characteristics and prices. However, competing items having significant differences can be included in a single assortment to provide a variety of choices to the customer. The competitor item sales 148 and competitor item profits 150 provide historical sales, profit and demand information on various competing items in the same category 120.

In some embodiments, the freshness of an item can be more important in the consideration by the computing system 104 than the brand of the item. For example, freshness of produce (such as apples) can be more important than the brand of the applies. In some embodiments, the brand of the item can be an important attribute 122 considered by the computing system 104. For example, particular brands of pharmaceutical products can be selected as having a higher priority over other brands. In some embodiments, the seasonality of an item can be considered. A variety of item attributes 122 can therefore be available for consideration by the computing system 104 when determining the assortment of the items.

The database 102 electronically stores data corresponding to a variety of shelf attributes 152. Such shelf attributes 152 can be considered by the computing system 104 when determining which items can be selected for display on a shelf based on the item attributes 122. The shelf attributes 152 can include (but are not limited to) shelf location 154, shelf category 156, shelf dimensions 158, or the like. The shelf location 154 can correspond to the physical location of the shelf within the retail environment. The shelf category 156 can correspond to the department in which the shelf is located and the one or more item categories 120 associated with a particular shelf (e.g., a shelf is generally associated with breakfast items). The shelf dimensions 158 can correspond to the physical characteristics or constraints of the shelf, such as the height, length, depth, width, height between shelves, the number of shelves at each shelving unit, or the like.

With reference to FIGS. 1 and 2, the computing system 104 can be configured to electronically receive as input at the GUI 112 a selection of an item category from the item categories 120 stored in the database 102. For example, if the user is interested in determining an optimal or near optimal assortment of items for the category of breakfast items, such category can be selected via input at the GUI 112. In some embodiments, two or more item categories 120 can be selected at the GUI 112 for simultaneous assortment.

Based on the selection of the item category 120, the computing system 104 can be configured to electronically determine or correlate the items associated with the selected item category 120, and attributes 122 of such items. Each item category 120 can be associated with a large number of items (e.g., over 100 items, or the like), including different competing brands. The number of items associated with each item category 120 can be stored in the database as the total number of items 160.

In some embodiments, the computing system 104 can rank the items in the selected item category 120 based on a profit-to-dimension ratio, with the ranking being electronically stored in the database 102 as item ranking 164. The item ranking 164 can therefore determine which items provide the most profits while requiring the least amount of facing space on the shelf. The item ranking 164 generally lists items having the highest profit-to-dimension ratio at the top, with a gradually diminishing ratio until the item with the lowest profit-to-dimension ratio is at the bottom of the listing.

Traditionally, selection and assortment of items to achieve optimal sales has been a computer resource and time consuming and inefficient, with the execution/processing time necessary for optimal assortment growing exponentially with the growth of the number of items in a particular item category 120. As will be discussed below, the exemplary system 100 applies a combination of the first and second modules 116, 118 to efficiently generate the optimal assortment of items for one or more item categories 120 in a manner that can significantly reduce the execution/processing time required by the system, reducing the overall time for determining such assortment based on a polynomial execution/processing time.

In particular, the computing system 104 is configured to select only a sample of the items 162 from the total number of items 160 for the selected item category 120. The sample of items 162 includes a fraction or subset of the total number of items 160 associated with the selected item category 120. The computing system 104 can select the sample of items 162 in an automated manner based on the item attributes 122 such that the sample of items 162 results in an accurate representation of the total number of items 160 of the selected item category 120. The sample of items 162 can therefore include items having a high-volume sales history, a mid-volume sales history, and a low-volume sales history, to represent items with varying sales histories.

The computing system 104 can be configured to execute the first module 116 to generate a first assortment 166 of the sample of items 160 based on the item attributes 122 and the shelf attributes 152. The first module 116 can be executed by the computing system 104 according to a non-polynomial processing time (e.g., an exponentially growing model or algorithm). The first module 116 determines a variety of combinations of the items in the non-polynomial processing time to determine the best or optimal combination of items for the item and shelf attributes. Due to the small number of items selected in the sample of items 162, the first module 116 outputs the first assortment 166 in a timely manner. The first module 116 optimizes the profit and/or sales of the sample of items 160 based on the capacity of one or more shelves. The first assortment 166 can incorporate unique items that may have greater success in attracting customers.

The computing system 104 also executes the second module 118 to generate a second assortment 168 of the sample of items 162 based on the item attributes 122 and the shelf attributes 152. The second module 118 can be executed according to a polynomial processing time (e.g., a heuristic model). In some embodiments, the second module 118 can rank each of the sample of items 162 according to the sales history per linear foot of the shelf to determine the optimal assortment. The second module 118 also uses data corresponding to top selling and/or fastest selling items in determining the second assortment 168.

In some embodiments, the second module 118 can first select the top selling item to include in the second assortment 168, with other items having high sales and/or unique characteristics being selected for inclusion next. The top selling item is therefore generally included in the second assortment 168. In some embodiments, if an item is unique but has a low sales history, the second module 118 can elect to include a different item that has a higher sales history (e.g., an item that is more marketable). In some embodiments, the second module 118 can select items for inclusion in the assortment specifically based on the sales data for such items (e.g., selecting items having the top 80% of sales for the category). Each of the first and second assortments 166, 168 includes data corresponding to the items to be displayed on the shelf, the number of items receiving a facing position (e.g., at the front of the shelf), the aisle and/or bin of the shelf, which shelf of a shelving unit receives the items, combinations thereof, or the like.

After both the first and second assortment 166, 168 for the sample of items 162 has been generated, the computing system 104 can be configured to validate the second assortment 168 based on the first assortment 166. In particular, the first module 116 generally determines the optimal assortment of the sample of items 162, but would be inefficient or impractical to use for a larger number of items (e.g., the total number of items 160). In particular, as the number of items considered for assortment increases, the processing time for determining the optimal or near optimal assortment by the first module 116 would increase significantly (e.g., exponentially) as compared to the second module 118. Particularly, the second module 118 executes in a time-efficient, polynomial manner and is used to obtain an assortment as close to the optimal assortment of the first module 116. The computing system 104 therefore determines how closely the second assortment 168 matches the first assortment 166.

In some embodiments, validation of the second assortment 168 can be performed based on an assortment criteria input by the user via the GUI 112 for the selected item category 120. In some embodiments, the assortment criteria can be in the form of an assortment level percentage 170. The assortment level percentage 170 can be a percentage value below 100%. For example, if the user is satisfied with the assortment generated by the second module 118 to be below 100% (e.g., 90%), the computing system 104 validates the second assortment 168 if the second assortment 168 meets or exceeds the assortment level percentage 170. As a further example, if the second assortment 168 is found to be at approximately 92% as compared to the first assortment 166, the computing system 104 can output a signal indicating that the second assortment 168 has been validated.

If the computing system 104 determines that the second assortment 168 is below the assortment level percentage 170 (e.g., not validated), the computing system 104 can execute the second module 118 again until the newly generated second assortment 168 has been validated. Validation of the second assortment 168 indicates that the second module 118 has reached the optimal or near optimal assortment generated by the first module 116. In some embodiments, the system 100 can use one or more machine-learning techniques (e.g., linear regression), with the second module 118 applying historical assortment data to improve and fine-tune the assortment results over time.

Once the second assortment 168 has been validated by the computing system 104, the computing system 104 can execute the second module 118 to generalize the second assortment 168 to the total number of items 160 associated with the selected item category 120. In particular, the second module 118 is executed according to a polynomial processing time, thereby outputting a generalized assortment 172 for the total number of items 160 in a timely manner. It should be understood that if the first module 116 was used for the assortment of the total number of items 160, the time needed to perform the non-polynomial execution of the first module 116 would grow exponentially as the number of items increases, resulting in an inefficient and inconvenient assortment determination.

In contrast, the second module 118 determines the generalized assortment 172 in a polynomial processing time, with an increase in the number of total items having a minimal effect on the overall processing time. The second module 118 is therefore capable of balancing the goal of increased sales with the dimensional restrictions of the shelves for outputting the optimal or near optimal assortment of items. The generalized assortment 172 can be output at the GUI 112, and can include data corresponding to the items to be displayed on the shelf, the number of items receiving a facing position (e.g., at the front of the shelf), the aisle and/or bin of the shelf, which shelf of a shelving unit receives the items, combinations thereof, or the like. In some embodiments, the output to the GUI 112 of the generalized assortment 172 can be in the form of a diagrammatic/digital representation of the shelving system with an indication of the items to be displayed at each shelf.

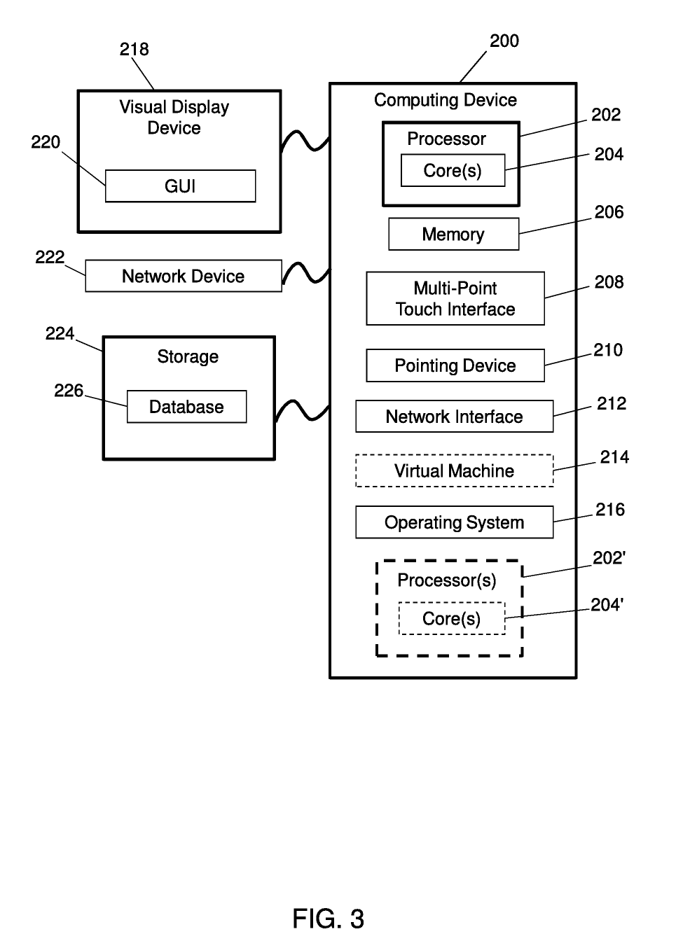

FIG. 3 is a block diagram of a computing device 200 in accordance with exemplary embodiments of the present disclosure. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in the computing device 200 may store computer-readable and computer-executable instructions or software for implementing exemplary embodiments of the present disclosure (e.g., instructions for operating the computing system 104, instructions for operating the processing device 106, instructions for operating the user device 110, instructions for executing the first module 116, instructions for executing the second module 118, instructions for operating the communication network 114, combinations thereof, or the like). The computing device 200 also includes configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in the computing device 200 so that infrastructure and resources in the computing device 200 may be shared dynamically. A virtual machine 214 may be provided to handle a process running on multiple processors so that the process appears to be using only one computing resource rather than multiple computing resources. Multiple virtual machines may also be used with one processor. Memory 206 may include a computer system memory or random access memory, such as DRAM, SRAM, EDO RAM, and the like. Memory 206 may include other types of memory as well, or combinations thereof.

A user may interact with the computing device 200 through a visual display device 218 (e.g., a personal computer, a mobile smart device, or the like), such as a computer monitor, which may display one or more user interfaces 220 (e.g., GUI 112) that may be provided in accordance with exemplary embodiments. The computing device 200 may include other I/O devices for receiving input from a user, for example, a keyboard or any suitable multi-point touch interface 208, a pointing device 210 (e.g., a mouse), or the like. The keyboard 208 and the pointing device 210 may be coupled to the visual display device 218. The computing device 200 may include other suitable conventional I/O peripherals.

The computing device 200 may also include one or more storage devices 224, such as a hard-drive, CD-ROM, or other computer readable media, for storing data and computer-readable instructions and/or software that implement exemplary embodiments of the system 100 described herein. Exemplary storage device 224 may also store one or more databases 226 for storing any suitable information required to implement exemplary embodiments. For example, exemplary storage device 224 can store one or more databases 226 for storing information, such as data relating to item categories 120, total number of items 160, sample of items 162, item attributes 122, shelf attributes 152, first assortment 166, second assortment 168, generalized assortment 172, assortment level percentage 170, item ranking 164, combinations thereof, or the like, and computer-readable instructions and/or software that implement exemplary embodiments described herein. The databases 226 may be updated by manually or automatically at any suitable time to add, delete, and/or update one or more items in the databases.

The computing device 200 can include a network interface 212 configured to interface via one or more network devices 222 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 212 may include a built-in network adapter, network interface card, PCMCIA network card, card bus network adapter, wireless network adapter, USB network adapter, modem or any other device suitable for interfacing the computing device 200 to any type of network capable of communication and performing the operations described herein. Moreover, the computing device 200 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 200 may run any operating system 216, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 216 may be run in native mode or emulated mode. In an exemplary embodiment, the operating system 216 may be run on one or more cloud machine instances.

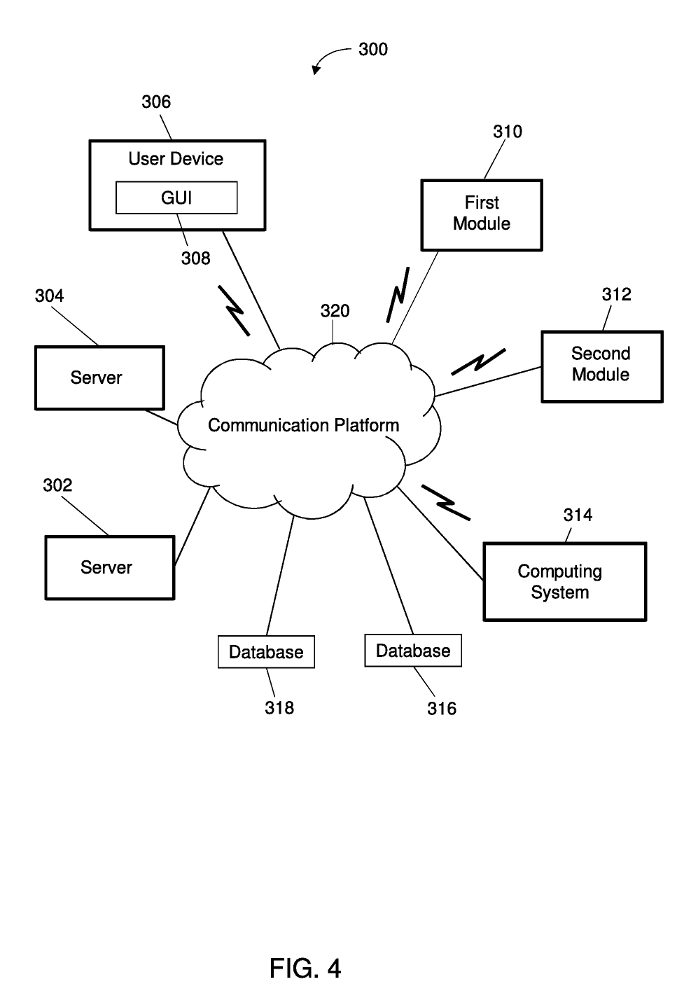

FIG. 4 is a block diagram of an exemplary distributed system environment 300 for automated item assortment selection in accordance with exemplary embodiments of the present disclosure. The environment 300 can include servers 302, 304 configured to be in communication with user devices 306 (having a GUI 308), first module 310, second module 312, and computing system 314, via a communication platform 320, which can be any network over which information can be transmitted between devices communicatively coupled to the network. For example, the communication platform 320 can be the Internet, Intranet, virtual private network (VPN), wide area network (WAN), local area network (LAN), and the like. In some embodiments, the communication platform 320 can be part of a cloud environment. The environment 300 can include repositories or databases 316, 318, which can be in communication with the servers 302, 304, as well as the user devices 306, first module 310, second module 312, and computing system 314, via the communications platform 320.

In exemplary embodiments, the servers 302, 304, user devices 306, first module 310, second module 312, computing system 314, and databases 316, 318, can be implemented as computing devices (e.g., computing device 200). Those skilled in the art will recognize that the databases 316, 318 can be incorporated into one or more of the servers 302, 304 such that one or more of the servers 302, 304 can include databases 316, 318. In some embodiments, the databases 316, 318 can store data relating to item categories 120, total number of items 160, sample of items 162, item attributes 122, shelf attributes 152, first assortment 166, second assortment 168, generalized assortment 172, assortment level percentage 170, item ranking 164, combinations thereof, or the like.

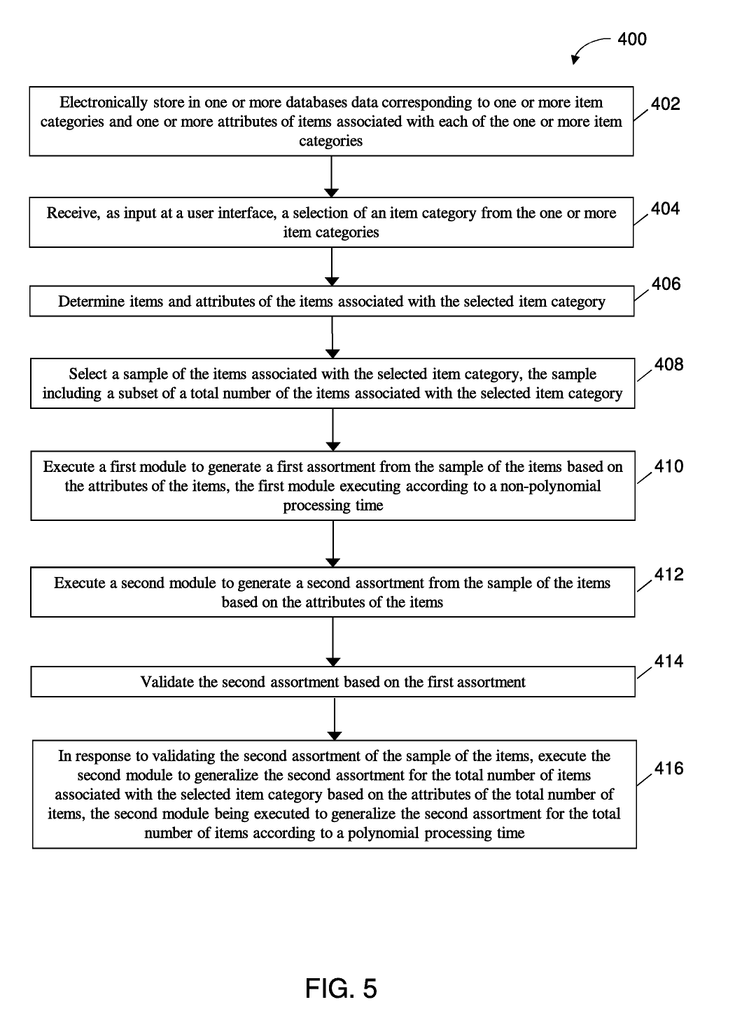

FIG. 5 is a flowchart illustrating an exemplary process 400 as implemented by embodiments of the system 100. To begin, at step 402, data corresponding to one or more item categories and one or more attributes of items associated with each of item categories can be electronically stored in one or more databases. At step 404, a selection of an item category from the one or more item categories can be received as input at a user interface. At step 406, items and attributes of the items associated with the selected item category can be determined.

At step 408, a sample of the items associated with the selected item category can be selected. The sample can include only a subset of the total number of items associated with the selected item category. At step 410, the first module can be executed to generate a first assortment of the sample of the items based on the attributes of the items and shelf attributes. The first module can execute according to a non-polynomial processing time. At step 412, the second module can be executed to generate a second assortment from the sample of the items based on attributes of the items and shelf attributes. At step 414, the second assortment can be validated based on the first assortment. At step 416, in response to validating the second assortment, the second module can be executed to generalize the second assortment for the total number of items associated with the selected item category based on attributes for the total number of items and shelf attributes. Such generalization by the second module is executed according to a polynomial processing time.

Thus, the exemplary system initially executes a combination of a non-polynomial time module and a polynomial time module for a sample of selected items to determine an optimal or near optimal assortment for the sample using the polynomial time module, and further generalizes the validated polynomial time module on the total number of items. Such generalization of the validated polynomial time module achieves the optimal or near optimal assortment solution for the total number of items in a time efficient manner without incurring exponential growth and significantly increased wait times for the output assortment.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A system for solving a non-deterministic polynomial-time problem associated with automated item assortment selection from a plurality of items, comprising:
one or more databases configured to electronically store data corresponding to one or more item categories and one or more attributes of items associated with each of the one or more item categories; and
a computing system in communication with the one or more databases, the computing system being configured to:
receive, as input at a user interface, a selection of an item category from the one or more item categories;
determine items and attributes of the items associated with the selected item category;
select a sample of the items associated with the selected item category, the sample including a subset of a total number of the items associated with the selected item category;
execute a first module to generate a first assortment from the sample of the items based on the attributes of the items, the first module executing according to a non-polynomial processing time;
execute a second module to generate a second assortment from the sample of the items based on the attributes of the items;
validate the second assortment based on the first assortment; and
in response to validating the second assortment of the sample of the items, execute the second module to generalize the second assortment for the total number of items associated with the selected item category based on the attributes of the total number of items, the second module being executed to generalize the second assortment for the total number of items according to a polynomial processing time.

2. The system of claim 1, wherein the one or more attributes of the items include at least one of an item name, item dimensions, item volume, item linear space, item price, item sales information, item profits, item demand, item historical data, item category, item uniqueness, competitor item similarity, competitor item sales, competitor item profits.

3. The system of claim 1, wherein the one or more databases are configured to electronically store data corresponding to one or more attributes of shelves in the one or more item categories.

4. The system of claim 3, wherein the one or more attributes of the shelves include at least one of a shelf location, a shelf category, or shelf dimensions.

5. The system of claim 1, wherein the computing system is configured to rank the items based on a profit-to-dimension ratio.

6. The system of claim 5, wherein the items with a high profit-to-dimension ratio are ranked higher than items with a low profit-to-dimension ratio.

7. The system of claim 1, wherein the selected sample of the items includes a combination of items with a high-volume sales history, items with a mid-volume sales history, and items with a low-volume sales history.

8. The system of claim 1, wherein the selected sample of the items is representative of the total number of the items associated with the selected item category.

9. The system of claim 1, wherein the first module determines the first assortment of the sample of the items based on shelf dimensions of one or more shelves of the selected item category.

10. The system of claim 1, wherein the first assortment of the sample of the items includes a location of each item on a shelf and a number of each item on the shelf.

11. The system of claim 1, wherein the computing system is configured to receive as input at the user interface an assortment criteria for the selected item category in the form of an assortment level percentage.

12. The system of claim 11, wherein the assortment level percentage is below 100%.

13. The system of claim 11, wherein the computing system is configured to validate the second assortment of the sample of the items based on whether the second assortment meets or exceeds the assortment criteria.

14. The system of claim 1, wherein the computing system is configured to output to the user interface a generalized assortment for the total number of items associated with the selected item category based on the generalization of the second assortment.

15. The system of claim 1, wherein the first module is a mixed integer model.

16. The system of claim 1, wherein the second module is a meta-heuristic model.

17. A non-transitory computer-readable medium storing instructions for solving a non-deterministic polynomial-time problem associated with automated item assortment selection from a plurality of items that are executable by a processing device of a computing system, wherein execution of the instructions by the processing device causes the processing device to:
electronically store in one or more databases data corresponding to one or more item categories and one or more attributes of items associated with each of the one or more item categories;
receive, as input at a user interface, a selection of an item category from the one or more item categories;
determine items and attributes of the items associated with the selected item category;
select a sample of the items associated with the selected item category, the sample including a subset of a total number of the items associated with the selected item category;
execute a first module to generate a first assortment from the sample of the items based on the attributes of the items, the first module executing according to a non-polynomial processing time;
execute a second module to generate a second assortment from the sample of the items based on the attributes of the items;
validate the second assortment based on the first assortment; and
in response to validating the second assortment of the sample of the items, execute the second module to generalize the second assortment for the total number of items associated with the selected item category based on the attributes of the total number of items, the second module being executed to generalize the second assortment for the total number of items according to a polynomial processing time.

18. The medium of claim 17, wherein:
execution of the instructions by the processing device causes the processing device to rank the items based on a profit-to-dimension ratio;
execution of the instructions by the processing device causes the processing device to execute the first module to determine the first assortment of the sample of the items based on shelf dimensions of one or more shelves of the selected item category; and
execution of the instructions by the processing device causes the processing device to output to the user interface a generalized assortment for the total number of items associated with the selected item category based on the generalization of the second assortment

19. The medium of claim 17, wherein:
execution of the instructions by the processing device causes the processing device to receive as input at the user interface an assortment criteria for the selected item department in the form of an assortment level percentage; and
execution of the instructions by the processing device causes the processing device to validate the second assortment of the sample of the items based on whether the second assortment meets or exceeds the assortment criteria.

20. A method of solving a non-deterministic polynomial-time problem associated with automated item assortment selection from a plurality of items, comprising:
electronically storing in one or more databases data corresponding to one or more item categories and one or more attributes of items associated with each of the one or more item categories;
receiving, as input at a user interface, a selection of an item category from the one or more item categories;
determining items and attributes of the items associated with the selected item category;
selecting a sample of the items associated with the selected item category, the sample including a subset of a total number of the items associated with the selected item category;
executing a first module to generate a first assortment from the sample of the items based on the attributes of the items, the first module executing according to a non-polynomial processing time;
executing a second module to generate a second assortment from the sample of the items based on the attributes of the items;
validating the second assortment based on the first assortment; and
in response to validating the second assortment of the sample of the items, executing the second module to generalize the second assortment for the total number of items associated with the selected item category based on the attributes of the total number of items, the second module being executed to generalize the second assortment for the total number of items according to a polynomial processing time.
